(19) United States
(12) Patent Application Publication
(10) Pub. No.: US 2003/0053794 A1
(43) Pub. Date: Mar. 20, 2003

(54) Method and device for digital data magnetic recording and reproduction of composite video signals

(76) Inventors: Alexei Krouglov, Etobicoke (CA); Daniel Gudmunson, Newmarket (CA)

Correspondence Address: Mark B. Eisen, Dimock Stratton Clarizio, Suite 3202, Box 102, 20 Queen Street West, Toronto, ON, M5H 3R3, CA

(21) Appl. No.: 09/955,066

(22) Filed: Sep. 19, 2001

(51) Int. Cl. H04N 5/76

(52) U.S. Cl. 386/95; 386/124

(57) ABSTRACT

A method and device for performing digital signal magnetic recording and reproduction in analog format on a medium, using a conventional analog video tape recorder (VTR). The digital signal is digitally modulated and inserted into the active part of scan lines of a standard composite video signal, and converted to an analog signal for storage on the medium. When the signal is reproduced from the medium, the analog signal is converted to a digital composite video signal, and the modulated data is extracted from the active part of the scan lines and demodulated to restore the original digital signal. To improve the synchronization between the demodulation and modulation stages, during demodulation the color burst of the composite video signal may be used as a pilot signal to recover the sampling clock and regenerate the one or multiple carriers. Error correction coding may be employed to reduce the signal-to-noise ratio of the reproduced signal.

### FIELD OF THE INVENTION

This invention is generally directed to the magnetic recording/reproduction of a digital signal on an analog video tape recorder (VTR). In particular, this invention relates to a method and device for recording and reproduction of a digital video signal such as MPEG-compressed video on an analog video tape recorder.

### BACKGROUND OF THE INVENTION

As modern technology undergoes a gradual transformation from analog to digital processing techniques, various kinds of digital recording and reproducing methods have been proposed for various applications. One such application is a digital signal magnetic recorder/reproducer.

Although the digital signal magnetic recorder/reproducer, which records and reproduces a digital video signal, is excellent in terms of picture quality and dubbing performance in comparison with an analog signal magnetic recorder/reproducer, which records and reproduces an analog video signal, the storage efficiency of the digital signal magnetic recorder/reproducer is inferior to its analog counterpart. The quantity of data which a digital signal magnetic recorder/reproducer must record on tape may be over ten times as much as the data recorded by a comparable analog signal magnetic recorder/reproducer in recording the same video signal. In order to realize high-density digital recording, multiple value digital modulation methods such as quadrature amplitude modulation (QAM) and quadrature phase shift keying modulation (QPSK) have been introduced. This increased efficiency in utilizing frequency bands permits high-density recording. The digital signal magnetic recorder/reproducer performs a digital-to-analog conversion at the start, processes the converted signal, converts the processed signal into a multiple-value signal at the time of encoding, records the converted multiple value signal, and decodes the signal by maximum likelihood decoding after demodulating the signal recorded in analog form, and finally performs an analog-to-digital conversion.

After recording and consecutive reproduction of an analog signal on the magnetic tape, the reproduced signal may be substantially deteriorated. Different kinds of errors may be introduced during the recording/reproducing process. Such errors include time-base errors, which are caused by several factors including (a) tape stretch, (b) temperature-induced expansion and contraction of the tape binder, and (c) minute distortions and ripples on the tape surface caused by head impacts. Time-base errors require time-base correction to meet the specifications of the composite signal. Other errors are caused by a failure to synchronize the sampling clock used during the demodulation process with the clock used in the modulation process.

EIAJ Standard CP-2901, “Consumer-Use PCM Encoder-Decoder” (1992) standardizes the technique of Pulse-Code Modulation (PCM) to record digital audio on NTSC analog videotape. To improve synchronization between the modulation and demodulation processes, it is known to provide a circuit for generating and combining a pilot signal with the output of the modulator and later restoring the carrier signal during the demodulation process. To improve synchronization during the decoding of the analog composite video signal, genlock circuitry is provided to regenerate the subcarrier and lock it to the subcarrier of the video signal being digitized.

However, these techniques do not satisfactorily resolve the problem of errors being introduced in the recording/reproducing process.

### SUMMARY OF THE INVENTION

The present invention provides a system and method for magnetically recording and reproducing a high-density digital signal on an analog medium, such as an analog video tape, which incorporates error correction coding to substantially reduce signal-to-noise ratios and reproduce the original data with high quality and fidelity to the original signal.

According to the recording method of the invention, the digital signal is modulated using one or multiple carriers and the modulated signal is inserted into the active part of scan lines of a digital composite video signal. The digital composite video signal is then converted from digital to analog form, which allows the signal to be recorded on a conventional analog video tape recorder. To reproduce the signal, it is first converted from analog to digital form, then the active part of scan lines is extracted from the digital composite video signal and demodulated.

In particular, according to the invention the digital signal is recorded by:

digitally modulating the digital signal with at least one carrier; inserting the digitally modulated signal into an active part of the scan lines of a composite video signal;

converting the digital composite video signal to an analog composite video signal; and

storing the analog composite video signal on a medium (for example using an analog VTR). The digital signal is reproduced from the storage medium by: reading the analog composite video signal from the medium; converting the analog composite video signal to a digital composite video signal; extracting the digitally modulated data from the active part of the scan lines of the digital composite video signal; and

demodulating the extracted data to regenerate the digital signal.

In the preferred embodiment the color burst component of the composite video signal is used as a pilot signal, to recover the sampling clock and regenerate the carrier sinusoid. In a further preferred embodiment the method of the invention encodes the digital signal prior to digital modulation and decodes the digital signal following digital demodulation, to improve the bit error rate by virtue of the coding gain.

The invention further provides a device for recording and reproduction of a digital video signal, comprising a modulator for transforming digital data into an analog signal and a demodulator for demodulating the digitally modulated data extracted from the active portions of the digital composite video signal.

In the preferred embodiment the modulator comprises an error correcting coder, which encodes the digital data by generating redundancies therein; a digital carrier modulator which modulates the digital data with at least one carrier sinusoid; a digital active line inserter, which inserts the modulated digital data into the active part of scan lines of a digital composite video signal; and a digital-to-analog converter, which transforms the digital composite video signal into an analog composite video signal.

In the preferred embodiment the demodulator comprises an analog-to-digital converter for converting the analog composite video signal to a digital composite video signal, a digital active line detector for extracting the digitally modulated data from the active part of scan lines of the digital composite video signal; a digital carrier demodulator for demodulating the digital data; a decoder for decoding the demodulated signal; and a synchronizing device, in the preferred embodiment a genlock unit, for regenerating the carrier sinusoid and locking it to the carrier sinusoid of the video signal being digitized. Preferably the genlock unit uses the colour burst component of the digital composite video signal as a pilot signal to restore synchronization between the regenerated carrier sinusoid and the carrier sinusoid of the original video signal.

The invention further provides an analog automatic gain circuit for restoring nominal values of the analog composite video signal before conversion to digital, and a digital automatic gain circuit for restoring nominal values of the digital composite video signal before extracting digitally modulated data from the active part of scan lines of the digital composite video signal.

The modulation method by which the digital signal is modulated may comprise any available modulation technique, including phase-shift keying modulation, quadrature amplitude modulation, orthogonal frequency division multiplexing, wavelet frequency division multiplexing, or any other suitable modulation technique.

Unlike prior art methods, the method of the invention provides a high-density recording on a conventional analog video tape recorder and low bit error rate. The invention permits users of analog VTRs to record any type of digital data, digital video data in particular, on the analog devices and to reproduce the original data with high quality and high fidelity to the original data.

The present invention thus provides a method of recording a digital signal onto a medium in an analog format, comprising the steps of a. digitally modulating the digital signal with at least one carrier to generate a digitally modulated digital signal; b. inserting the digitally modulated digital signal into an active part of scan lines of a digital composite video signal; c. converting the digital composite video signal to an analog composite video signal; and d. storing the analog composite video signal on a storage medium.

In a further aspect the method of the invention comprises a method of reproducing the digital signal, comprising the steps of: e. reading the analog composite video signal from the medium; f. converting the analog composite video signal to a digital composite video signal; g. extracting the digitally modulated digital signal from the active part of scan lines of the digital composite video signal; and h. demodulating the digitally modulated digital signal to provide the digital signal.

The present invention further provides a method of reproducing a digital signal stored in an analog format on a medium, the digital signal being processed prior to storage by digitally modulating the digital signal with at least one carrier to generate a digitally modulated digital signal; inserting the digitally modulated digital signal into an active part of scan lines of a digital composite video signal; converting the digital composite video signal to an analog composite video signal; and storing the analog composite video signal on a storage medium; comprising the steps of: a. reading the analog composite video signal from the medium; b. converting the analog composite video signal to a digital composite video signal; c. extracting the digitally modulated digital signal from the active part of scan lines of the digital composite video signal; and d. demodulating the digitally modulated digital signal to provide the digital signal.

In further aspects of the method of the invention: the storage medium is a video tape recorder; before step (a), the digital signal is encoded and after step (h), the digital signal is decoded; the digital signal is modulated and demodulated using phase-shift keying, quadrature amplitude modulation, orthogonal frequency division multiplexing or wavelet frequency division multiplexing; and/or a colour burst portion of the digital composite video signal is used as a pilot signal to recover a sampling clock of the digital signal.

The present invention further provides a device for storing a digital signal in an analog format on a medium and reproducing a digital signal from the stored analog signal, comprising: a modulator for storing a digital signal in an analog format, comprising a digital carrier modulator for digitally modulating the digital signal with at least one carrier to generate a digitally modulated digital signal, a digital active line inserter for inserting the digitally modulated digital signal into an active part of scan lines of a digital composite video signal, and a digital-to-analog converter for converting the digital composite video signal to an analog composite video signal for storage on the medium; and a demodulator comprising: an analog-to-digital converter for converting the analog composite video signal to a digital composite video signal, an active line detector for extracting digital data from the active part of scan lines of the digital composite video signal, a digital carrier demodulator for demodulating the extracted digital data, and a genlock device for regenerating the at least one carrier and synchronizing the regenerated carrier to the original carrier with which the digital signal was digitally modulated, wherein the genlock device uses a colour burst component of the digital composite video signal as a pilot signal.

In further aspects of the device of the invention: the modulator further comprises an encoder for encoding the digital signal prior to modulation and the demodulator further comprises a decoder for decoding the digital signal after demodulation; the storage medium is videotape; the device further comprises a video tape recorder; the digital signal is modulated and demodulated using phase-shift keying, quadrature amplitude modulation, orthogonal frequency division multiplexing or wavelet frequency division multiplexing; the demodulator further comprises analog automatic gain control, for restoring nominal values of the analog composite video signal prior to conversion of the analog composite video signal to a digital composite video signal; and/or the demodulator further comprises digital automatic gain control, for restoring nominal values of the digital composite video signal after conversion of the analog composite video signal to a digital composite video signal.

### BRIEF DESCRIPTION OF THE DRAWINGS

In drawings which illustrate by way of example only a preferred embodiment of the invention,

FIG. 1 is a schematic diagram showing one horizontal line period of a composite video signal,

FIG. 2 is a block diagram of a preferred embodiment of the device of the invention,

FIG. 3 is a block diagram of the modulator of FIG. 2,

FIG. 4A is a block diagram of the demodulator of FIG. 2 with an analog automatic gain control circuit,

FIG. 4B is a block diagram of the demodulator of FIG. 2 with a digital automatic gain control circuit,

FIG. 5 is a block diagram of the genlock circuitry of FIG. 4, and

FIG. 6 is a schematic diagram of a method of quadrature amplitude modulation.

### DETAILED DESCRIPTION OF THE INVENTION

The invention is applicable to the recording and reproduction of a digital signal on an analog VTR, and is particularly advantageously used in the recording and reproduction of a digital video signal, for example MPEG-compressed video.

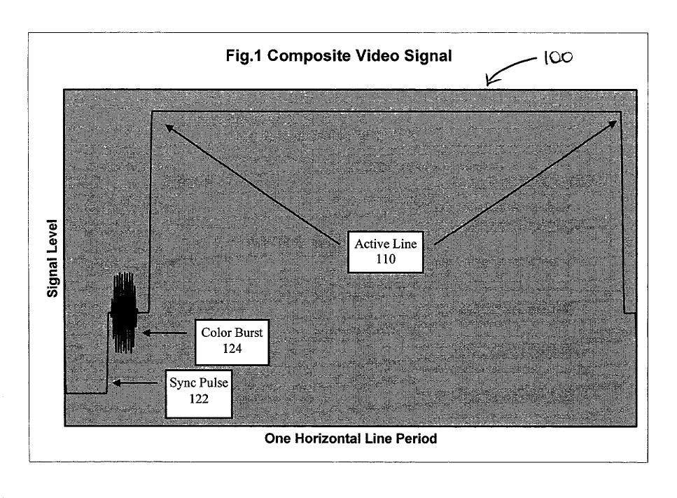

Referring to FIG. 1, a horizontal line period 100 of a composite video signal is illustrated. In accordance with SMPTE Standard 170M-1999 entitled “Composite Analog Video Signal—NTSC for Studio Applications,” which is incorporated herein by reference, each horizontal scan line outside the vertical blanking interval of a composite video signal is divided into an active line period 110 and a horizontal blanking interval 120. The horizontal blanking interval 120 comprises a negative horizontal synchronizing pulse 122 followed by a color-synchronizing color burst component 124. The remainder of the horizontal blanking interval 120 is at blanking level to properly space the sync pulse and color burst 122, 124. The active line period 110 carries the information actually visible on the display screen of a television or monitor (not shown).

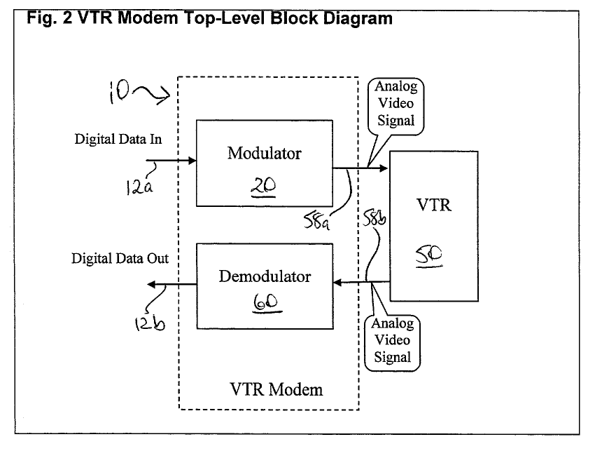

An analog VTR records and reproduces a composite video signal containing a series of horizontal line periods 100. To store a digital signal using an analog VTR, the digital signal data must be represented in an analog format. To reproduce the digital signal, the analog signal must be converted back to digital format. FIG. 2 is a high-level block diagram illustrating the recording/reproducing device 10 of the invention, connected to a VTR 50.

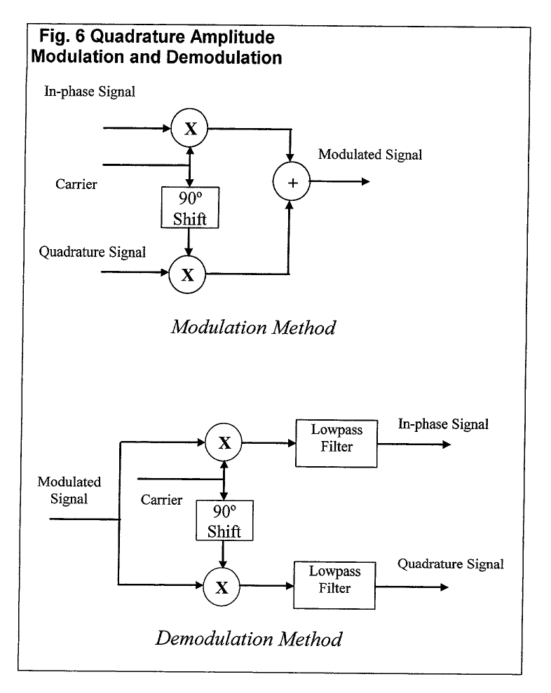

According to the invention, when a digital signal 12a is to be recorded the digital signal 12a is modulated with a single carrier sinusoid 28, or optionally multiple carrier sinusoids, generated by carrier generator 26. For example, a sinusoid signal with the NTSC color subcarrier frequency would be a suitable carrier wave for the digital modulation process, as the resulting waveform is within the frequency range of most conventional analog VTRs. The carrier 28 may be modulated using any suitable modulation method, preferably one which provides high-density recording such as quadrature phase-shift keying modulation (QPSK), quadrature amplitude modulation (QAM), orthogonal frequency division multiplexing (OFDM) or wavelet frequency division multiplexing (WDM). FIG. 6 illustrates QAM modulation by way of example, however many other modulation techniques are suitable for use in the invention and the invention is not intended to be limited thereby.

The modulated digital data 32 is then inserted by video active line inserter 38 into the active portion of horizontal scan lines in the digital composite video signal generated by video signal generator 34. To insert the modulated data the modulated signal 32 is divided into smaller portions, the size of each portion (active part of scan line) being determined by the sampling rate. For example, in an NTSC signal with a 13.5 MHz sampling rate, the number of pixels in the active line is 720 and total number of pixels in the scan line is 858; in 4×Fsc with a 14.3 MHz sampling rate, the number of pixels in the active line is 768 and total number of pixels in the scan line is 910.

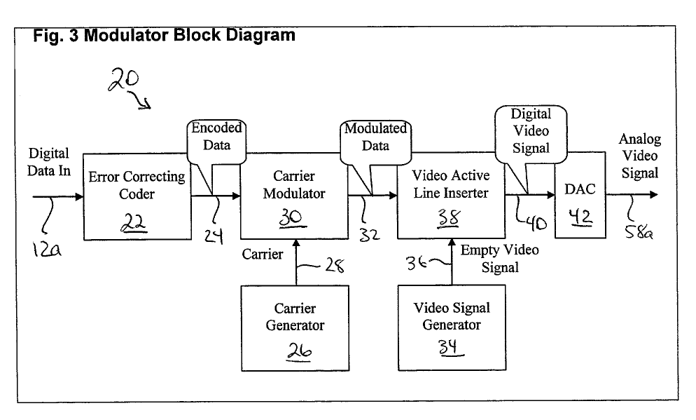

After the modulated digital data 32 has been inserted into the active portion of horizontal scan lines, the digital composite video signal 40 is converted to an analog composite video signal 58a by a digital-to-analog converter (DAC) 42 incorporated into the modulator 20, as shown in FIG. 3. The resultant analog video signal 58a is output to a conventional VTR 50 for storage on the videotape medium.

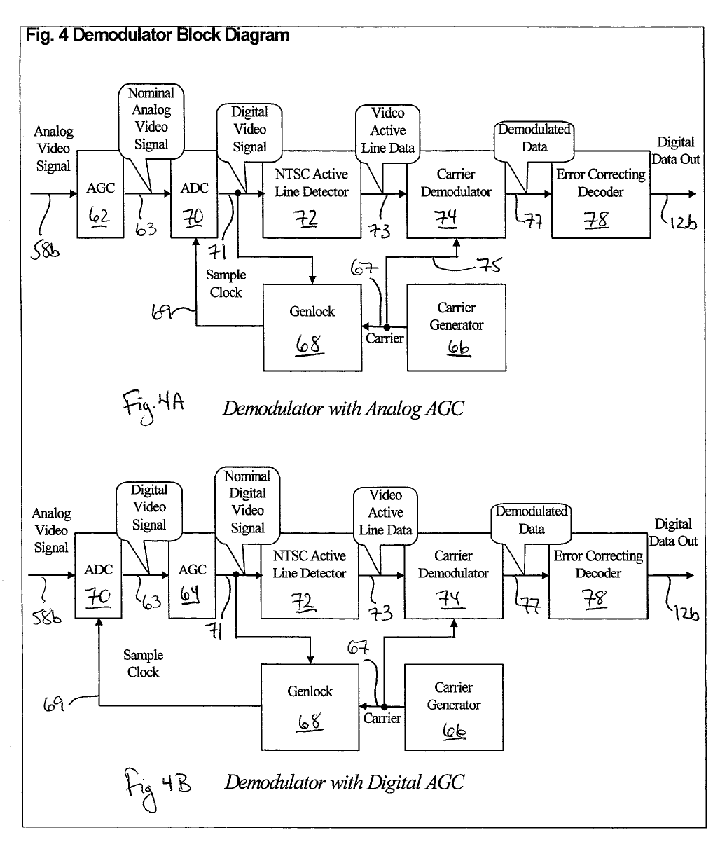

When the data is to be reproduced from the recording of the analog signal 58a, the VTR 50 plays back the analog signal, designated 58b in FIG. 4. The analog output signal 58b from the VTR 50 is fed through the demodulator 80, illustrated in FIG. 4, which provides analog-to-digital conversion and demodulation of the signal to provide digital data 12b.

When the data is to be reproduced from the recording of the analog composite video signal 58a, referring to FIGS. 4A and 4B, the VTR 50 plays back the analog composite video signal 58b which is output to an analog-to-digital converter (ADC) 70 to convert the analog composite video signal 58b to a digital composite video signal 71. Optionally the analog composite video signal 58b is fed through an analog automatic gain control (AGC) circuit 62, shown in FIG. 4A, to restore the nominal values of the analog composite video signal 58b prior to conversion to a digital composite video signal 71. Alternatively, or additionally, the demodulator 60 may comprise a digital automatic gain control (AGC) circuit 64, shown in FIG. 4B, for restoring nominal values of the digital composite video signal 71 after conversion by ADC 70.

The digital composite video signal 71 is output to an active line detector 72, which extracts the modulated digital data stored in the active portions 110 of scan lines of the composite digital video signal 71. Preferably the digital signal 71 is simultaneously output to a genlock unit 68, which facilitates synchronization of the signal by restoring the sampling clock signal 69. Carrier signal generator 66 generates a carrier signal 67 which is output both to the genlock unit 68 and to the carrier demodulator 74. The demodulator 74 receives the extracted video active line data 73 from active line detector 72 and demodulates the signal, outputting the restored digital signal 77.

The digital video data 12a is preferably encoded before modulation, to implement a technique of error correction coding. As shown in FIG. 3, the input data stream 12a is fed to an encoder 22 which adds redundant bits, which are used to identify bit errors in the restored digital signal output by the demodulator 60. The redundant bits allow for correction of some of the error data distorted during the recording and reproducing process. If the digital data signal 12a has been error-correction encoded by an encoder 22, the demodulated data 77 is similarly processed through a decoder 78 to produce the final digital output signal 12b, as shown in FIG. 4. Though the bit rate of the data which can be actually recorded on the medium is lost by error correction coding, error correction coding yields a substantial gain because it allows the method and device of the invention to yield the same bit error rates as if the input data signal 12a were not encoded, but with significantly smaller signal-to-noise ratios (up to several decibels). There are several known methods of data encoding which can be implemented in the invention, as will be known to those skilled in the art, the two biggest classes utilizing linear block codes and convolutional codes.

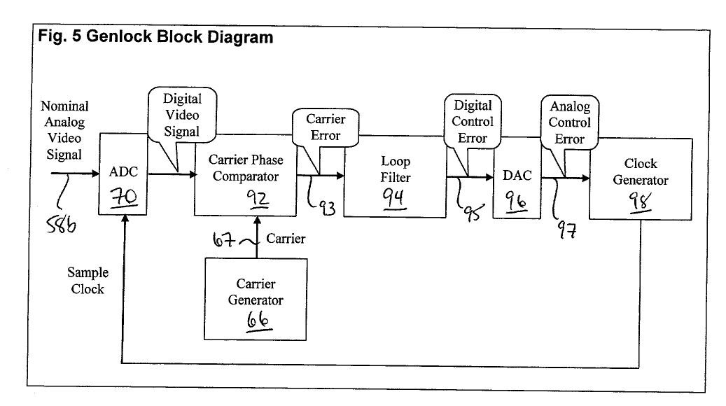

During the demodulation process it is important to synchronize the sampling clock with a system clock used at the time of modulation. The genlock circuitry 68 is shown in detail in FIG. 5. To improve synchronization of the carrier signal 67 applied during the demodulation stage to the phase of the carrier signal 28 applied during modulation, the genlock unit 68 locks the carrier signal 67 to the color subcarrier of the video signal 71, in the preferred embodiment using the color burst component of the composite video signal as the pilot to recover the sampling clock. The carrier signal 67 from carrier generator 66 is output to a carrier phase comparator 92, which produces a digital carrier error 93 based on the color burst 124. The carrier error 93 is processed by filter loop 94 to yield a digital control error 95, which is converted to an analog control error signal 97 by DAC 96. This analog control error signal 97 drives the clock generator 98, which produces the required pixel clock frequency to provide the sample clock synchronization signal to the ADC 70. Where the digital data input signal 12a is encoded prior to modulation, a similar procedure must be employed during decoding of the composite video signal, in which case the composite video decoder 78 contains similar genlock circuitry.

By way of example only, using 16 QAM for digital modulation with a 3.58− MHz carrier coinciding with NTSC colour subcarrier frequency, ⅔ convolutional encoder for error correction coding, and estimating approximately 80% active pixel capacity per scan line, a digital stream of 7.6 Mb/s (3.58 M×4×0.8×0.67) may be recorded in real time. Thus, for example, a 5 Mb/s MPEG-2 video stream may be recorded in real time under these parameters.

Various embodiments of the present invention having been thus described in detail by way of example, it will be apparent to those skilled in the art that variations and modifications may be made without departing from the invention. For example, alternate modulation methods besides QPSK, QAM, OFDM and WDM may be used; or other methods of error correction may be applied to the digital video data. The invention includes all such variations and modifications as fall within the scope of the appended claims.

We claim:

1. A method of recording a digital signal onto a medium in an analog format, comprising the steps of
a. digitally modulating the digital signal with at least one carrier to generate a digitally modulated digital signal;
b. inserting the digitally modulated digital signal into an active part of scan lines of a digital composite video signal;
c. converting the digital composite video signal to an analog composite video signal; and
d. storing the analog composite video signal on a storage medium.

2. The method of claim 1 wherein the storage medium is a video tape recorder.

3. The method of claim 2 including, before step (a), the step of encoding the digital signal.

4. The method of claim 2 wherein the digital signal is modulated in step (a) using phase-shift keying, quadrature amplitude modulation, orthogonal frequency division multiplexing or wavelet frequency division multiplexing.

5. The method of claim 2 further comprising a method of reproducing the digital signal, comprising the steps of:
e. reading the analog composite video signal from the medium;
f. converting the analog composite video signal to a digital composite video signal;
g. extracting the digitally modulated digital signal from the active part of scan lines of the digital composite video signal; and
h. demodulating the digitally modulated digital signal to provide the digital signal.

6. The method of claim 5 further comprising the step of using a colour burst portion of the digital composite video signal as a pilot signal to recover a sampling clock of the digital signal.

7. The method of claim 6 including, after step (h), the step of decoding the digital signal.

8. The method of claim 7 wherein the digital signal is demodulated in step (h) using phase-shift keying, quadrature amplitude modulation, orthogonal frequency division multiplexing or wavelet frequency division multiplexing.

9. A method of reproducing a digital signal stored in an analog format on a medium, the digital signal being processed prior to storage by digitally modulating the digital signal with at least one carrier to generate a digitally modulated digital signal; inserting the digitally modulated digital signal into an active part of scan lines of a digital composite video signal; converting the digital composite video signal to an analog composite video signal; and storing the analog composite video signal on a storage medium; comprising the steps of:
a. reading the analog composite video signal from the medium;
b. converting the analog composite video signal to a digital composite video signal;
c. extracting the digitally modulated digital signal from the active part of scan lines of the digital composite video signal; and
d. demodulating the digitally modulated digital signal to provide the digital signal.

10. The method of claim 9 comprising the step of using a colour burst portion of the digital composite video signal as a pilot signal to recover a sampling clock of the digital signal.

11. The method of claim 10 wherein prior to processing the digital signal for storage the digital signal was encoded, including, after step (d), the step of
e. decoding the digital signal.

12. The method of claim 11 wherein the digital signal is demodulated in step (d) using phase-shift keying, quadrature amplitude modulation, orthogonal frequency division multiplexing or wavelet frequency division multiplexing.

13. A device for storing a digital signal in an analog format on a medium and reproducing a digital signal from the stored analog signal, comprising
a modulator for storing a digital signal in an analog format, comprising
a digital carrier modulator for digitally modulating the digital signal with at least one carrier to generate a digitally modulated digital signal;
a digital active line inserter for inserting the digitally modulated digital signal into an active part of scan lines of a digital composite video signal; and
a digital-to-analog converter for converting the digital composite video signal to an analog composite video signal for storage on the medium; and
a demodulator comprising:
an analog-to-digital converter for converting the analog composite video signal to a digital composite video signal;
an active line detector for extracting digital data from the active part of scan lines of the digital composite video signal;
a digital carrier demodulator for demodulating the extracted digital data; and
a genlock device for regenerating the at least one carrier and synchronizing the regenerated carrier to the original carrier with which the digital signal was digitally modulated, wherein the genlock device uses a colour burst component of the digital composite video signal as a pilot signal.

14. The device of claim 13 wherein the modulator further comprises an encoder for encoding the digital signal prior to modulation and the demodulator further comprises a decoder for decoding the digital signal after demodulation.

15. The device of claim 14 wherein the storage medium is videotape.

16. The device of claim 15 further comprising a video tape recorder.

17. The device of claim 14 wherein the digital signal is modulated and demodulated using phase-shift keying, quadrature amplitude modulation, orthogonal frequency division multiplexing or wavelet frequency division multiplexing.

18. The device of claim 14 wherein the demodulator further comprises analog automatic gain control, for restoring nominal values of the analog composite video signal prior to conversion of the analog composite video signal to a digital composite video signal.

19. The device of claim 18 wherein the demodulator further comprises digital automatic gain control, for restoring nominal values of the digital composite video signal after conversion of the analog composite video signal to a digital composite video signal.

20. A digital signal processing device comprising the device of claim 14.
